(19) United States
(12) Patent Application Publication
(10) Pub. No.: US 2024/0422315 A1
(43) Pub. Date: Dec. 19, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Meng WANG, Hong Kong (CN); Kai ZHANG, Los Angeles, CA (US); Li ZHANG, Los Angeles, CA (US)

(21) Appl. No.: 18/818,353

(22) Filed: Aug. 28, 2024

Related U.S. Application Data
(63) Continuation of application No. PCT/CN2023/078585, filed on Feb. 28, 2023.

(30) Foreign Application Priority Data
Feb. 28, 2022 (WO) PCT/CN2022/078453

(51) Int. Cl. H04N 19/12; H04N 19/33

(52) U.S. Cl. CPC H04N 19/12; H04N 19/33

(57) ABSTRACT

Embodiments of the present disclosure provide a solution for video processing. A method for video processing is proposed. The method comprises: applying, during a conversion between a video unit of a video and a bitstream of the video unit, a compression process to the video unit based on a compression framework, wherein the compression framework comprises a transform skip module; and performing the conversion based on the compressed video unit.

### CROSS-REFERENCE TO RELATED APPLICATIONS

This application is a continuation of International Application No. PCT/CN2023/078585, filed on Feb. 28, 2023, which claims the benefit of Chinese Application No. PCT/CN2022/078453 filed on Feb. 28, 2022. The entire contents of these applications are hereby incorporated by reference in their entireties.

### FIELDS

Embodiments of the present disclosure relates generally to video processing techniques, and more particularly, to system and method for learned image compression.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: applying, during a conversion between a video unit of a video and a bitstream of the video unit, a compression process to the video unit based on a compression framework, wherein the compression framework comprises a transform skip module; and performing the conversion based on the compressed video unit. The method in accordance with the first aspect of the present disclosure introduces a transform skip module in the compression framework, which can advantageously improve the coding efficiency and performance.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: applying a compression process to a video unit of the video based on a compression framework, wherein the compression framework comprises a transform skip module; and generating a bitstream of the video based on the compressed video unit.

In a fifth aspect, a method for storing a bitstream of a video is proposed. The method comprises: applying a compression process to a video unit of the video based on a compression framework, wherein the compression framework comprises a transform skip module; generating a bitstream of the video based on the compressed video unit; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a framework according to an example embodiment of the present disclosure;

FIG. 5 illustrates a framework according to another example embodiment of the present disclosure;

FIG. 6 illustrates a framework according to a further embodiment of the present disclosure;

FIG. 7 illustrates a flowchart of a method for video processing in accordance with embodiments of the present disclosure; and

FIG. 8 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

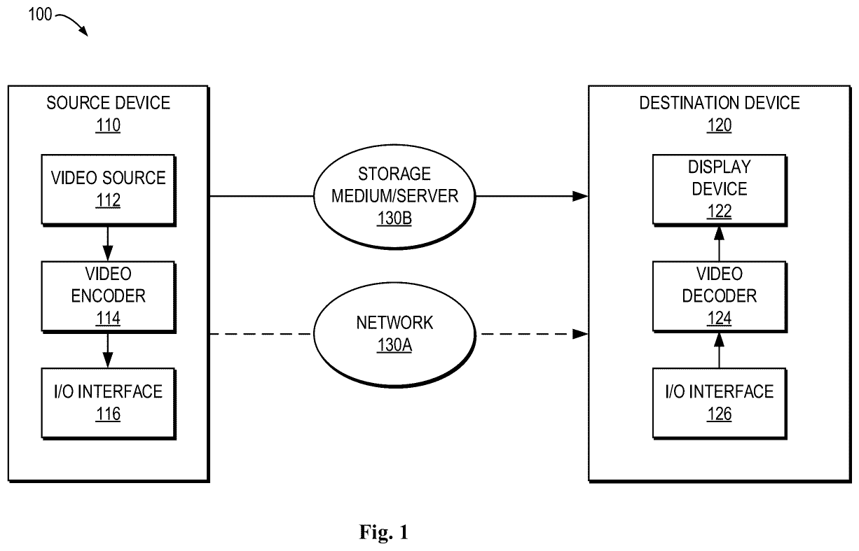

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

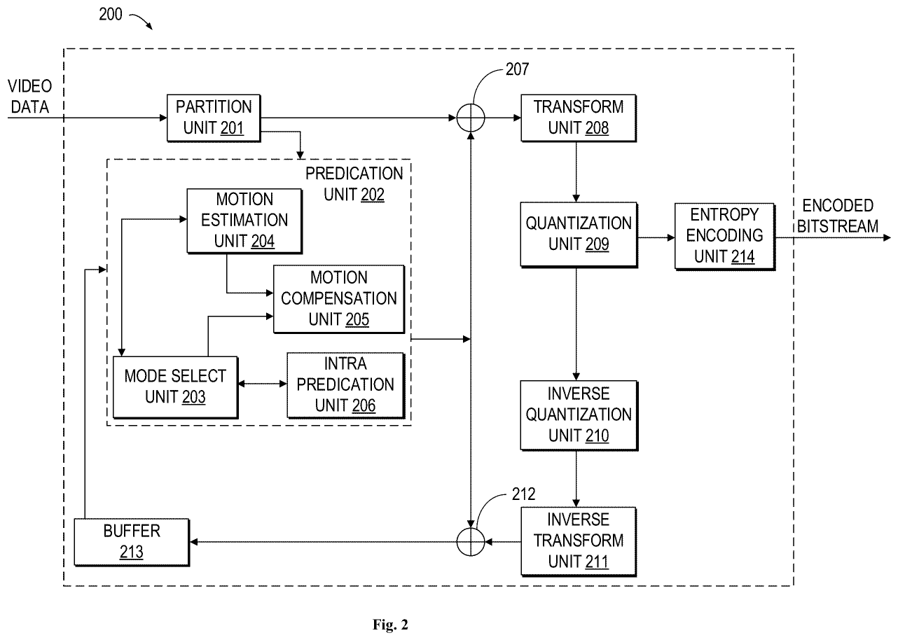

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

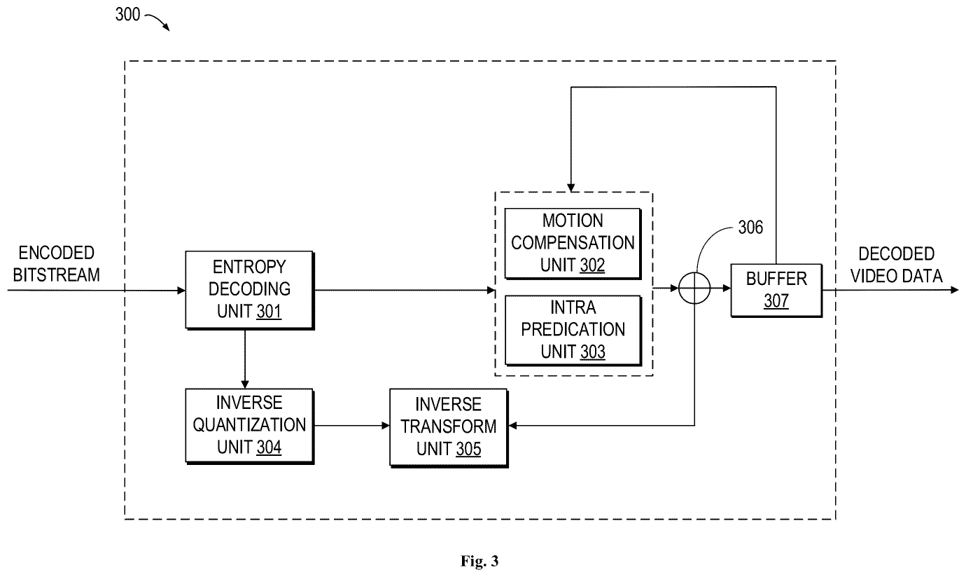

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

The present disclosure is related to image/video processing technologies. Specifically, it is about algorithm design for image compression. The ideas may be applied individually or in various combination, to any image/video coding system or part of coding and decoding process.

### 2. INTRODUCTION

Recent years have witnessed the rapid development of the digital devices, such that the screen content images and videos become one of the prominent media in daily communication. The data volumes of screen content are explosively increased, introducing considerable challenges to the image and video coding technologies. Meanwhile, when confronting with the new application scenarios such as on-line education, virtual meeting and cloud gaming, investigating high efficient screen content coding scheme is highly desirable. Image and video coding aims at compactly interpreting the digital image and video signals under the constraint of tolerable degradation of the visual quality, with which the storage space and transmission bandwidth could be effectively reduced and economized.

Generally speaking, screen content is an umbrella-term of the computer-generated or rendered data characterized with noise-free, sharp-edges and high contrast. In the past decades, a series of efforts have been dedicated to improving the compression performance of the screen content. In the new generations of coding standards such as the Versatile Video Coding (VVC), screen content coding is involved as low-level compression tools, orienting to the compression performance improvement of the screen sharing, animation, gaming, as well as the mixture of the text and natural scene content. To be more specific, VVC has adopted five screen content coding tools, including the intra block copy, palette, transform skip with residual coding, adaptive color transform, and block based differential pulse-coded modulation. The screen content coding tools could seamlessly collaborate with the scene characteristic and the coding characteristic of screen content. It was reported that the screen content coding tools could bring additional 33.22% BD-Rate savings, laying the foundation of versatile usage of the VVC.

With the surging of the deep learning, deep neural network has been widely employed in compressing and processing of visual signals. In the literature, numerous learning-based schemes have been investigated, which can be classified into two categories. In the first category, the traditional coding modules such as the in-loop filters, intra prediction, and inter prediction are substituted by the deep neural network, with the goal of enhancing the prediction and reconstruction ability. The second category achieves the compression in an end-to-end manner, which optimizes the overall rate and distortion performance through a trainable network. Typically, the end-to-end image codec delicately combines convolutional neural network, recurrent neural network, generalized divisive normalization (GDN) layer, and attention layer, aiming at interpreting the spatial visual signals as latent code through non-linear transformation. Then, quantization and entropy coding are cooperated. The visual signal could be recovered through the trainable synthesizing modules. A typical end-to-end image compression framework may contain four main modules, The forward transform module analyzes the input, and converts the input signals to latent code. The quantization is applied to the latent code, reducing the amount of information required to store or transmit. The entropy coding encodes the quantized latent code as bit-stream, and the entropy decoder parses the bitstream. At last, the synthesis transform is cooperated to reconstruct the image.

### 3. PROBLEMS

Existing end-to-end image compression schemes mainly focus on the natural scene image. However, the compression of the screen content images has not been fully explored. The characteristics of natural scene images and screen content images are different. In particular, natural scene images are captured by cameras which induces sensor noises. The noise-free screen content images are generated or rendered by computers, which generally contains repeated patterns, high-contrast texture, and sharp edges. These lead to the discrepancy of the statistical properties, which in turn affects the compression efficiency. Directly applying existing learning-based image compression scheme to screen content results in the degradation of the rate and distortion performance.

### 4. EMBODIMENTS OF THE PRESENT DISCLOSURE

To solve the above problems and some other problems not mentioned, methods as summarized below are disclosed. The embodiments below should be considered as examples to explain general concepts. These embodiments should not be interpreted in a narrow way. Furthermore, these embodiments can be combined in any manner.

In the following descriptions, the term ‘image compression’ may represent any variance of signal processing methods that compress or process the current input. The input images/videos include but not limited to the screen content and natural content.

To solve the problem, one or more of the following approaches are disclosed:
1. Introduce the transform skip module to the end-to-end compression framework.
   a) In one example, the transform skip module could be a long connection in the network that directly passes the input to any intermediate stages and/or final stages of the network.
   b) In one example, the transform skip module could be a subset of the end-to-end compression framework that contains less/shallower feature extraction units and larger scaling ratios.
2. Involve a transform skip module in the transform analysis stage. The input may be the visual signal or features of visual signal. The transform analysis branch contains T₁ feature extraction unit (e.g., convolution layer, residual block, combined with activation layers such as GDN). The associated scaling factor for the i-th feature extraction unit is S_{1,i}. The transform skip branch contains T₂ feature extraction unit (e.g., convolution layer, residual block). The associated scaling factor for the i-th feature extraction unit is S_{2,i}. T₂ should not be larger thanT₁. S_{1,i} and S_{2,i} should be non-negative.
   a) In one example, the transform skip branch may substitute the entire main transform branch.
      i. In one example, the number of feature extraction unit T₂ in the transform skip branch may be zero.
      ii. In one example, the number of feature extraction unit T₂ in the transform skip branch may be T₁/2. The S_{2,i} may equal to 2S_{1,i}.
      iii. In one example, the number of feature extraction unit T₂ in the transform skip branch may be T₁/4. The S_{2,i} may equal to 4S_{1,i}.
      iv. In one example, T₂ may equal to 2ⁿ, and S_{2,i} may equal to 2^{k}, where in n and k are positive values.
         1) In one example, n may be 4 and k may be 2.
         2) Alternatively, n may be 2 and k may be 4.
   b) In one example, partial of the feature extraction unit in the main transform branch may be replaced by the transform skip inspired feature extraction units. Typically, the transform skip inspired feature extraction units may have larger scaling ratio than feature extraction unit in the main transform branch.
      i. In one example, the first and/or the last feature extraction unit in the main transform branch may be reserved, and the middle units may be replaced by the transform skip inspired units.
         1) In one example, T₂ equals to (T₁−2)/2. The S_{2,i} may equal to 2S_{1,i}.
      ii. In one example, the first and/or the last feature extraction unit in the main transform branch may be replaced by the transform skip inspired feature extraction units. The middle units in the main transform branch are reserved.
      iii. Alternatively for example, any feature extraction unit in the main transform branch may be replaced by transform skip inspired feature extraction unit.
   c) In one example, the transform skip branch may be parallel to the main transform branch.
      i. In one example, the number of feature extraction unit T₂ in the transform skip branch may be zero.
      ii. In one example, the number of feature extraction unit T₂ in the transform skip branch may be T₁/2. The S_{2,i} may equal to 2S_{1,i}.
      iii. In one example, the number of feature extraction unit T₂ in the transform skip branch may be T₁/4. The S_{2,i} may equal to 4S_{1,i}.
      iv. In one example, T₂ may equal to 2ⁿ, and S_{2,i} may equal to 2^{k}, where in n and k are positive values.
         1) In one example, n may be 4 and k may be 2.
         2) In one example, n may be 4 and k may be 2. N may be 2 and S₂ may be 4.
3. Involve a transform skip branch in the hyperprior analysis stage. The input of the hyperprior analysis stage is the latent code y. The hyperprior analysis branch contains H₁ feature extraction unit (e.g., convolution layer, residual block). The associated scaling factor for the i-th feature extraction unit is S_{1, i}. The transform skip hyperprior analysis branch contains H₂ feature extraction unit (e.g., convolution layer, residual block). The associated scaling factor for the i-th feature extraction unit is S_{2,i}. H₂ should not be larger than H₁. S_{1,i} and S_{2,i} should be non-negative.
   a) In one example, transform skip hyperprior analyzing branch may substitute the entire hyperprior analysis branch.
      i. In one example, the number of feature extraction unit H₂ in the transform skip hyperprior analysis branch may be zero.
      ii. In one example, the number of feature extraction unit H₂ in the transform skip hyperprior analysis branch may be H₁/2. The S_{2,i} may equal to 2S_{1,i}.
      iii. In one example, the number of feature extraction unit H₂ in the transform skip hyperprior analysis branch may be H₁/4. The S_{2,i} may equal to 4S_{1,i}.
      iv. In one example, H₂ may equal to 2ⁿ, and S_{2,i} may equal to 2^{k}, where in n and k are positive values.
         1) In one example, n may be 4 and k may be 2.
         2) Alternatively, n may be 2 and k may be 4.
   b) In one example, partial of the feature extraction unit in the hyperprior analysis branch may be replaced by the transform skip inspired hyperprior extraction units. Typically, the transform skip inspired hyperprior extraction units may have larger scaling ratio than hyperprior extraction unit in the main hyperprior analysis branch.
      i. In one example, the first and/or the last feature extraction unit in the main hyperprior analysis branch may be reserved, and the middle units may be replaced by the transform skip inspired hyperprior extraction units.
         1) In one example, H₂ equals to (H₁−2)/2. The S_{2,i} may equal to 2S_{1,i}.
      ii. In one example, the first and/or the last hyperprior extraction unit in the main hyperprior analysis branch may be replaced by the transform skip inspired hyperprior extraction units. The middle units in the main hyperprior analysis are reserved.
      iii. Alternatively for example, any hyperprior extraction unit in the main hyperprior analysis may be replaced by transform skip inspired hyperprior extraction units.
   c) In one example, the transform skip hyperprior analysis branch may be parallel to the hyperprior analysis branch.
      i. In one example, the number of feature extraction unit H₂ in the transform skip branch may be zero.
      ii. In one example, the number of feature extraction unit H₂ in the transform skip branch may be H₁/2. The S_{2,i} may equal to 2S_{1,i}.
      iii. In one example, the number of feature extraction unit H₂ in the transform skip branch may be H₁/4. The S_{2,i} may equal to 4S_{1,i}.
      iv. In one example, H₂ may equal to 2ⁿ, and S_{2,i} may equal to 2^{k}, where in n and k are positive values.
         1) In one example, n may be 4 and k may be 2.
         2) In one example, n may be 4 and k may be 2. N may be 2 and S₂ may be 4.
4. Involve a transform skip branch in the hyperprior synthesis stage. The input of the hyperprior synthesis stage is the latent code of the hyper-prior \hat{z}. The main hyperprior synthesis branch contains H₃ hyperprior reconstruction unit (e.g., convolution layer, residual block). The associated scaling factor for the i-th reconstruction unit is S_{3, i}. The transform skip inspired hyperprior synthesis branch contains H₄ hyperprior reconstruction unit (e.g., convolution layer, residual block). The associated scaling factor for the i-th feature reconstruction unit is S_{4,i}. H₄ should not be larger than H₃. S_{3,i} and S_{4,i} should be non-negative.
   a) In one example, transform skip hyperprior reconstruction branch may substitute the entire hyperprior synthesis branch.
      i. In one example, the number of hyperprior reconstruction unit H₄ in the transform skip hyperprior reconstruction branch may be zero.
      ii. In one example, the number of hyperprior reconstruction unit H₄ in the transform skip hyperprior reconstruction branch may be H₃/2. The S_{4,i} may equal to 2S_{3,i}.
      iii. In one example, the number of hyperprior reconstruction unit H₄ in the transform skip hyperprior reconstruction branch may be H₃/4. The S_{4,i} may equal to 4S_{3,i}.
      iv. In one example, H₄ may equal to 2ⁿ, and S_{4,i} may equal to 2^{k}, where in n and k are positive values.
         1) In one example, n may be 4 and k may be 2.
         2) Alternatively, n may be 2 and k may be 4.
   b) In one example, partial of the hyperprior reconstruction unit in the hyperprior synthesis branch may be replaced by the transform skip inspired hyperprior reconstruction unit. Typically, the transform skip inspired hyperprior reconstruction units may have larger scaling ratio than hyperprior reconstruction unit in the main hyperprior synthesis branch.
      i. In one example, the first and/or the last hyperprior reconstruction unit in the main hyperprior synthesis branch may be reserved, and the middle units may be replaced by the transform skip inspired hyperprior reconstruction unit.
         1) In one example, H₄ equals to (H₃−2)/2. The S_{4,i} may equal to 2S_{3,i}.
      ii. In one example, the first and/or the last hyperprior reconstruction unit in the main hyperprior synthesis branch may be replaced by the transform skip inspired hyperprior reconstruction units. The middle units in the main hyperprior synthesis are reserved.
      iii. Alternatively for example, any hyperprior reconstruction unit in the main hyperprior synthesis may be replaced by transform skip inspired hyperprior reconstruction units.
   c) In one example, the transform skip hyperprior synthesis branch may be parallel to the hyperprior synthesis branch.
      i. In one example, the number of hyperprior reconstruction unit H₄ in the transform skip hyperprior reconstruction branch may be zero.
      ii. In one example, the number of hyperprior reconstruction unit H₄ in the transform skip hyperprior reconstruction branch may be H₃/2. The S_{4,i} may equal to 2S_{3,i}.
      iii. In one example, the number of hyperprior reconstruction unit H₄ in the transform skip hyperprior reconstruction branch may be H₃/4. The S_{4,i} may equal to 4S_{3,i}.
      iv. In one example, H₄ may equal to 2ⁿ, and S_{4,i} may equal to 2^{k}, where in n and k are positive values.
         1) In one example, n may be 4 and k may be 2.
         2) Alternatively, n may be 2 and k may be 4.
5. Involve a transform skip branch in the final transform synthesis stage, which is responsible for reconstructing the output visual signals. The input may be the latent code ŷ from the entropy decoder. The transform synthesis branch contains T₃ feature reconstruction unit (e.g., convolution layer, residual block). The associated scaling factor for the i-th feature reconstruction unit is S_{3,i}. The transform skip inspired feature reconstruction branch contains T₄ feature reconstruction unit (e.g., convolution layer, residual block). The associated scaling factor for the i-th feature reconstruction unit is S_{4,i}. T₄ should not be larger than T₃. S_{3,i} and S_{4,i} should be non-negative.
   a) In one example, the transform skip inspired synthesis branch may substitute the entire main synthesis branch.
      i. In one example, the number of feature reconstruction unit T₄ in the transform skip branch may be zero.
      ii. In one example, the number of feature reconstruction unit T₄ in the transform skip branch may be T₃/2. The S_{4,i} may equal to 2S_{3,i}.
      iii. In one example, the number of feature reconstruction unit T₄ in the transform skip branch may be T₃/4. The S_{4,i} may equal to 4S_{3,i}.
      iv. In one example, T₄ may equal to 2ⁿ, and S_{4,i} may equal to 2^{k}, where in n and k are positive values.
         1) In one example, n may be 4 and k may be 2.
         2) Alternatively, n may be 2 and k may be 4.
   b) In one example, partial of the feature reconstruction unit in the main synthesis branch may be replaced by the transform skip inspired feature reconstruction units. Typically, the transform skip inspired feature reconstruction units may have larger scaling ratio than feature reconstruction unit in the main synthesis branch.
      i. In one example, the first and/or the last feature reconstruction unit in the main synthesis branch may be reserved, and the middle units may be replaced by the transform skip inspired units.
         1) In one example, T₄ equals to (T₃−2)/2. The S_{4,i} may equal to 2S_{3,i}.
      ii. In one example, the first and/or the last feature reconstruction unit in the main synthesis branch may be replaced by the transform skip inspired feature reconstruction units. The middle units in the main synthesis branch are reserved.
      iii. Alternatively for example, any feature reconstruction unit in the main synthesis branch may be replaced by transform skip inspired feature reconstruction unit.
   c) In one example, the transform skip branch may be parallel to the main synthesis branch.
   d) In one example, the transform skip inspired synthesis branch may substitute the entire main synthesis branch.
      i. In one example, the number of feature reconstruction unit T₄ in the transform skip branch may be zero.
      ii. In one example, the number of feature reconstruction unit T₄ in the transform skip branch may be T₃/2. The S_{4,i} may equal to 2S_{3,i}.
      iii. In one example, the number of feature reconstruction unit T₄ in the transform skip branch may be T₃/4. The S_{4,i} may equal to 4S_{3,i}.
      iv. In one example, T₄ may equal to 2ⁿ, and S_{4,i} may equal to 2^{k}, where in n and k are positive values.
         1) In one example, n may be 4 and k may be 2.
         2) Alternatively, n may be 2 and k may be 4.
6. The scaling factor controls the dimension changing of the features, where the dimension may be the spatial resolution (W×H), and channel-wise dimension (C).
   a) In one example, the dimension of the features may be constantly shrinking in encoding phases. By contrast, and the dimension of the features may be constantly enlarging (middle outputs) in the decoding phases. The final output picture/frame may be aligned to the size of the picture/frame.
      i. In one example, only spatial resolution is changing during encoding phase and decoding phase.
      ii. In one example, only channel-wise dimension is changing during encoding phase and decoding phase.
      iii. In one example, both spatial resolution and channel-wise dimension are changing during encoding phase and decoding phase.
      iv. In one example, whether to change the spatial resolution and/or channel-wise dimension will be signaled to the decoder side.
   b) Alternatively for example, the dimension of the features may not constantly shrink in the encoding phase. The dimension of the features may not constantly enlarge in the decoding phase. The up-scaling and down-scaling operations may be interlaced.
      i. In one example, the dimension change may only occur to the spatial resolution.
      ii. In one example, the dimension change may only occur to the channel-wise dimension.
      iii. In one example, the dimension change may both occur to the spatial resolution and the channel-wise dimension.
      iv. In one example, whether and how to employ the up-scaling and down-scaling operations will be signaled to the decoder.
7. The outputs of the main branch O₁ (e.g. main analysis branch, hyperprior analysis branch, hyperprior synthesis branch and main synthesis branch) and the outputs of corresponding transform inspired branch O₂ may be combined and fed to the next stage.
   a) In one example, the combination may be the weighted sum of O₁ and O₂.
      i. In one example, the associated weight may be 0.5.
      ii. In one example, the weight of O₁ may be 1, and the weight of O₂ may be zero.
      iii. In one example, the weight of O₂ may be 1, and the weight of O₁ may be zero.
      iv. In one example, the weight of O₁ may be w1, and the weight of O₂ may be w2. w1 and w2 should both be non-zero numbers.
      v. In one example, the weights of O₁ and O₂ may be signaled to the decoder side.
   b) In one example, the combination of O₁ and O₂ is through a convolutional layer with the size of N×N.
      i. In one example, N equals to 3.
      ii. In one example, N equals to 1.
8. Whether to retain the O₁ and O₂ may be adaptively selected and signaled.
   a) In one example, one flags may be signaled to indicate whether to retain the output of main analysis branch or the associated transform inspired analysis branch.
      i. Alternatively, one additional flag may be signaled if both outputs of the two branches will be retained.
   b) In one example, one flags may be signaled to indicate whether to retain the output of hyperprior analysis branch or the associated transform inspired hyperprior analysis branch.
      i. Alternatively, one additional flag may be signaled if both outputs of the two branches will be retained.
   c) In one example, one flags may be signaled to indicate whether to retain the output of the hyperprior synthesis branch or the associated transform inspired hyperprior synthesis branch.
      i. Alternatively, one additional flag may be signaled if both outputs of the two branches will be retained.
   d) In one example, one flags may be signaled to indicate whether to retain the output of the main synthesis branch or the associated transform inspired synthesis branch.
      i. Alternatively, one additional flag may be signaled if both outputs of the two branches will be retained.

### 5. EMBODIMENTS

Examples of end-to-end image compression process are illustrated as follows. A trasform skip branch is cooperated in the compression network. The inputs could be color pictures/frames/videos with three channels (e.g. RGB, YUV) or signal channel picures/frames/videos.

### 6. EMBODIMENT #1

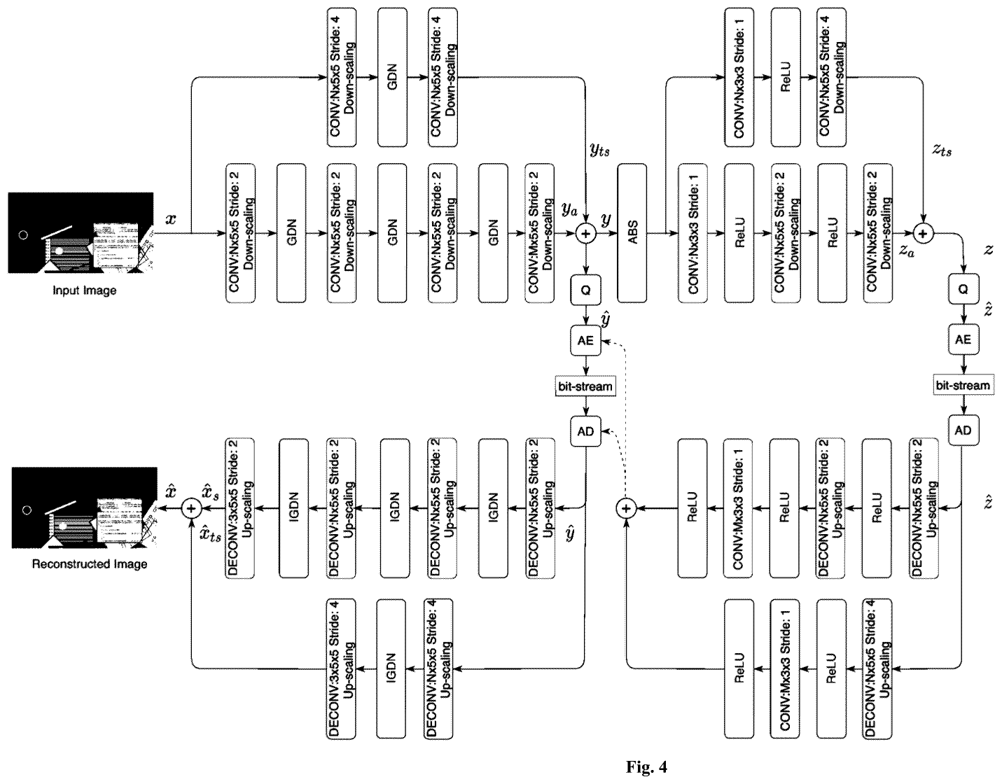

FIG. 4 illustrates a framework according to Embodiment #1. In this embodiment, the main forward analysis branch is composed with four convolutional layers interlaced with four GDN layers, wherein the stride of each convolutional layer is 2. The transform skip branch during the analysis process contains two convolutional layers and one GDN layers, and the stride of the convolutional layer is 4. The main forward analysis branch and the transform skip branch generate the latent code yₐ and yₜₛ, respectively. The latent code y for further entropy coding and probability estimation, is the sum of yₜₛ and yₐ.

In the hyperprior analysis stage, the main hyperprior analysis branch is composed with one 3×3 convolutional layer with stride 1, two 5×5 convolutional lyer with stride 2, and two ReLU layers. In the proposed transform skip branch, there are one 3×3 convolutional layer with stride 1, one 5×5 convolutional layer with stride 4 and a ReLU layer. The hyperprior parameter regarding the z is the sum of the outcomes of the main hyperprior analysis branch and transform skip branch.

During the hyperprior synthesis stage, the main synthesis stage is composed with two 5×5 decovolutional layers with stride 2, one 3×3 convolutional layer with stride 1 and three ReLU layers. In the proposed transform skip branch, it contains one 5×5 deconvolutional layer with stride 4, one 3×3 convolutional layer with stride 1 and two ReLU layers. The scale paratemter \hat{σ} is used for modelling the probability distribution of the latent ŷ.

In the synthesis stage, the main synthesis branch has four deconvolutional layers with stride 2 and four inverse-GDN (IGDN) layers, yielding the signal \hat{x}ₛ. The transform skip branch includes two deconvolutional layers with stride four and one IGDN layer, producing the signal \hat{x}ₜₛ. The final output visual signal is the sum of the \hat{x}ₛ and \hat{x}ₜₛ.

### 7. EMBODIMENT #2

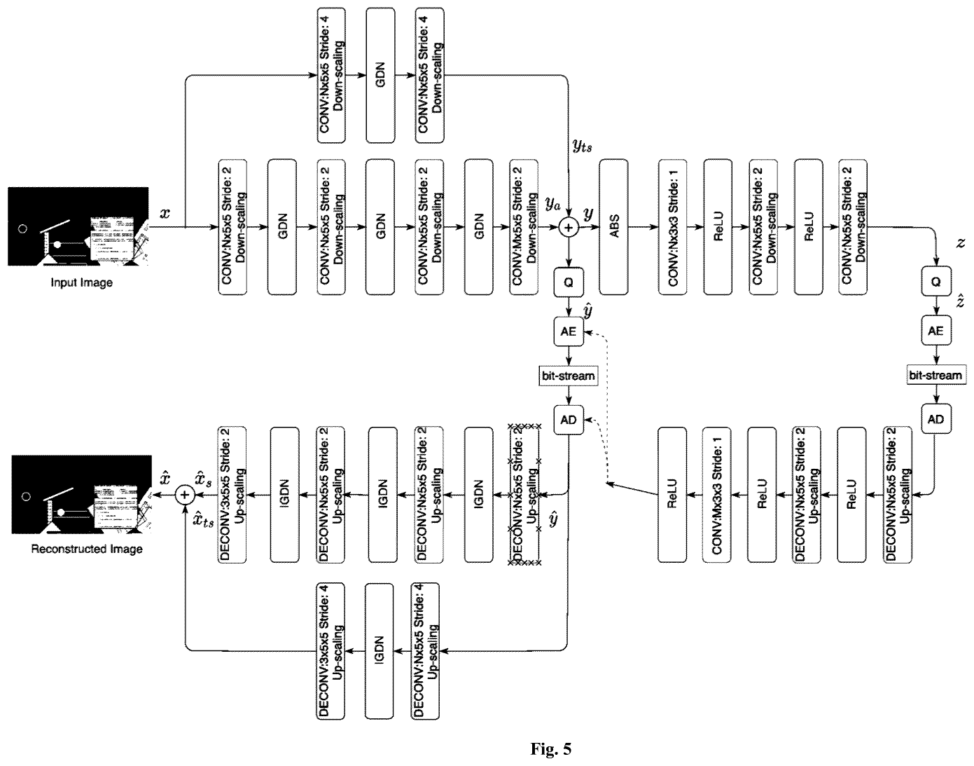

FIG. 5 illustrates a framework according to Embodiment #2. In this embodiment, the transform skip inspired branches are cooperated to the main forward analysis stage and the synthesis stage. The parameter configuration is identical to the Embodiment #1.

### 8. EMBODIMENT #3

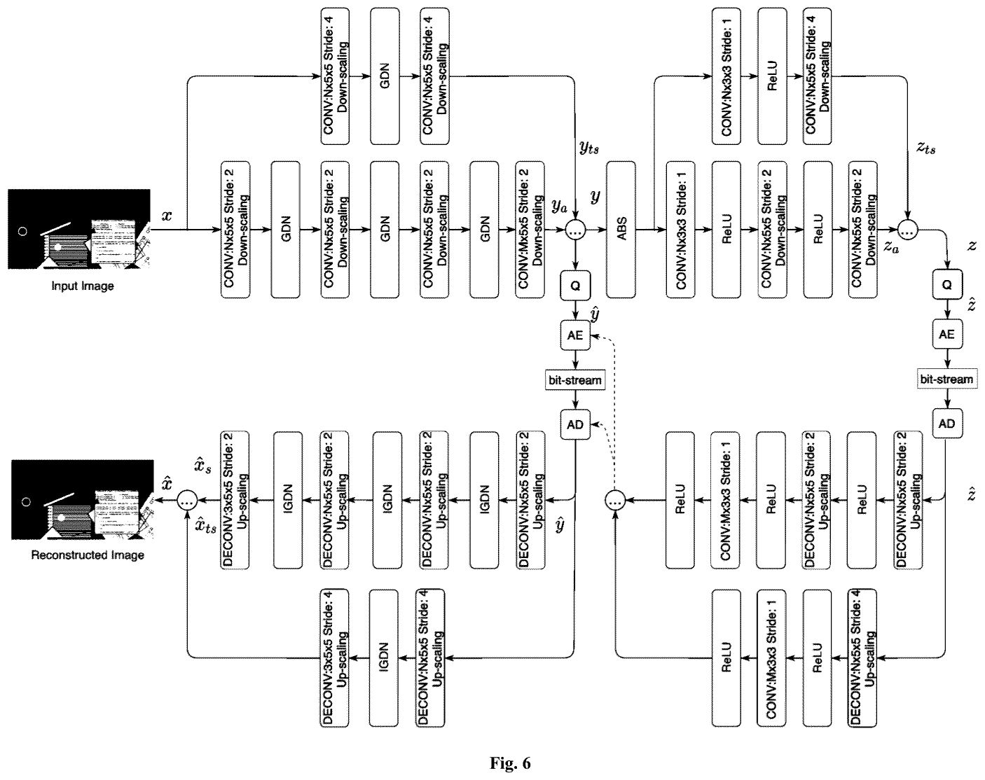

FIG. 6 illustrates a framework according to Embodiment #3. In this embodiment, the combination of yₐ and yₜₛ is realized through a convolutional layer (e.g. 1×1, stride=1). Analogously, the combination regarding the outcomes of main branch and transform skip branche could be achieved through a 1×1 convolutional layer (e.g. 1×1, stride=1).

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. The term “image compression” may represent any variance of signal processing methods that compress or process the current input. The input images/videos include but not limited to the screen content and natural content.

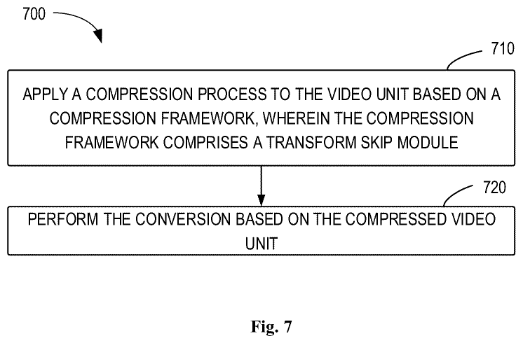

FIG. 7 illustrates a flowchart of a method 700 for video processing in accordance with embodiments of the present disclosure. The method 700 is implemented during a conversion between a video unit of a video and a bitstream of the video.

At block 710, during a conversion between a video unit of a video and a bitstream of the video unit, a compression process is applied to the video unit based on a compression framework. The compression framework comprises a transform skip module. At block 720, the conversion is performed based on the compressed video unit.

In some embodiments, the conversion may include encoding the video unit into the bitstream. Alternatively, or in addition, the conversion may include decoding the video unit from the bitstream. The method 700 enables applying a transform skip module to an end-to-end compression framework, thereby improving coding efficiency and performance.

In some embodiments, the transform skip module is a connection in the compression framework that directly passes an input signal related the video unit to at least one of: an intermediate stage or a final stage of the compression framework. In some embodiments, the transform skip module is a subset of the compression framework that comprises less feature extraction units and larger scaling ratios than those of other modules of the compression framework. In one example, the transform skip module could be a subset of the end-to-end compression framework that contains less/shallower feature extraction units and larger scaling ratios.

In some embodiments, the transform skip module is applied in a transform analysis stage of the compression process. An input of the transform analysis state may be a visual signal or features of the visual signal. A transform analysis branch in the transform analysis stage may comprise T₁ feature extraction units. A transform skip analysis branch that includes the transform skip module may comprise T₂ feature extraction units. T₂ may not be larger than T₁. T₁ and T₂ may be integer numbers. For example, the input may be the visual signal or features of visual signal. The transform analysis branch may include T₁ feature extraction unit (e.g., convolution layer, residual block, combined with activation layers such as GDN). The associated scaling factor for the i-th feature extraction unit may be S_{1,i}. The transform skip branch may include T₂ feature extraction unit (e.g., convolution layer, residual block). The associated scaling factor for the i-th feature extraction unit may be S_{2,i}.

In some embodiments, a transform skip analysis branch that includes the transform skip module substitutes an entire main transform branch of the compression framework. In some embodiments, the number of features extraction units in the transform skip analysis branch is zero.

In some embodiments, the number of feature extraction units in the transform skip analysis branch (i.e., T₂) is T₁/2 and S_{2,i} is equal to 2S_{1,i}. Alternatingly, the number of feature extraction units in the transform skip analysis branch is T₁/4 and S_{2,i} is equal to 4S_{1,i}. The S_{1,i} may represent a scaling factor for i-th feature extraction unit in the transform analysis branch, S_{2,i} may represent a scaling factor for i-th feature extraction unit in the transform skip analysis branch, and i may be an integer number.

In some embodiments, the number of feature extraction units in the transform skip analysis branch may equal to 2ⁿ, and S_{2,i} may equal to 2^{k}. In this case, n and k may be positive values. In one example, n may be 4 and k may be 2. Alternatively, n may be 2 and k may be 4.

In some embodiments, a portion of feature extraction units in a main transform branch is replaced by a set of feature extraction units related to transform skip. A feature extraction unit related to transform skip may comprise a larger scaling ratio than that of the feature extraction unit in the main transform branch of the compression framework. In one example, partial of the feature extraction unit in the main transform branch may be replaced by the transform skip inspired feature extraction units. Typically, the transform skip inspired feature extraction units may have larger scaling ratio than feature extraction unit in the main transform branch.

In some embodiments, at least one of: a first or a last feature extraction unit in the main transform branch is reserved, and feature extraction units in the middle of the main transform branch are replaced by the set of feature extraction units related to transform skip. In some embodiments, at least one of: a first or a last feature extraction unit in the main transform branch is replaced by the set of feature extraction units related to transform skip, and feature extraction units in the middle of the main transform branch are reserved.

In some embodiments, the number of feature extraction units related to transform skip in the transform skip analysis branch is (T₁−1)/2 and S_{2,i} is equal to 2S_{1,i}. The S_{1,i} may represent a scaling factor for i-th feature extraction unit in the transform analysis branch, S_{2,i} may represent a scaling factor for i-th feature extraction unit in the transform skip analysis branch, and i may be an integer number.

In some embodiments, one or more feature extraction units in the main transform branch is replaced by the set of feature extraction units related to transform skip. For example, any feature extraction unit in the main transform branch may be replaced by transform skip inspired feature extraction unit.

In some embodiments, a transform skip analysis branch that includes the transform skip module is parallel to a main transform branch of the compression framework. In some embodiments, the number of features extraction units in the transform skip analysis branch is zero.

In some embodiments, the number of feature extraction units in the transform skip analysis branch is T₁/2 and S_{2,i} is equal to 2S_{1,i}. Alternatively, the number of feature extraction units in the transform skip analysis branch is T₁/4 and S_{2,i} is equal to 4S_{1,i}. In this case, S_{1,i} may represent a scaling factor for i-th feature extraction unit in the transform analysis branch, S_{2,i} may represent a scaling factor for i-th feature extraction unit in the transform skip analysis branch, and i may be an integer number.

In some embodiments, the number of feature extraction units in the transform skip analysis branch is 2ⁿ and S_{2,i} is equal to 2^{k}. In this case, n and k are positive values. In one example, n may be 4 and k may be 2. In one example, n may be 4 and k may be 2. N may be 2 and S₂ may be 4.

In some embodiments, the transform skip module is applied in a hyperprior analysis stage of the compression process. In some embodiments, an input of the hyperprior analysis stage is latent code y. In some embodiments, a hyperprior analysis branch in the hyperprior analysis stage comprises H₁ feature extraction units. In some embodiments, a transform skip hyperprior analysis branch that includes the transform skip module comprises H₂ feature extraction units. In some embodiments, H₂ is not larger than H₁, H₁ and H₂ are integer numbers. For example, the input of the hyperprior analysis stage is the latent code y. The hyperprior analysis branch contains H₁ feature extraction unit (e.g., convolution layer, residual block). The associated scaling factor for the i-th feature extraction unit is S_{1,i}. The transform skip hyperprior analysis branch contains H₂ feature extraction unit (e.g., convolution layer, residual block). The associated scaling factor for the i-th feature extraction unit is S_{2,i}.

In some embodiments, the transform skip hyperprior analysis branch that includes the transform skip module substitutes an entire hyperprior analysis branch of the compression framework. In some embodiments, the number of features extraction units (i.e., H₂) in the transform skip hyperprior analysis branch is zero.

In some embodiments, the number of feature extraction units in the transform skip hyperprior analysis branch is H₁/2 and S_{2,i} is equal to 2S_{1,i}, or wherein the number of feature extraction units in the transform skip hyperprior analysis branch is H₁/4 and S_{2,i} is equal to 4S_{1,i}, and wherein S_{1,i} represents a scaling factor for i-th feature extraction unit in the hyperprior analysis branch, S_{2,i} represents a scaling factor for i-th feature extraction unit in the transform skip hyperprior analysis branch, and i is an integer number.

In some embodiments, the number of feature extraction units in the transform skip hyperprior analysis branch is 2ⁿ and S_{2,i} is equal to 2^{k}. In this case, n and k are positive values. In one example, n may be 4 and k may be 2. Alternatively, n may be 2 and k may be 4.

In some embodiments, a portion of feature extraction units in a hyperprior analysis branch is replaced by a set of feature extraction units related to transform skip, and a feature extraction unit related to transform skip comprises a larger scaling ratio than that of the feature extraction unit in the hyperprior analysis branch of the compression framework.

In some embodiments, at least one of: a first or a last feature extraction unit in the hyperprior analysis branch is reserved, and feature extraction units in the middle of the hyperprior analysis branch are replaced by the set of feature extraction units related to transform skip. In some embodiments, the number of feature extraction units related to transform skip in the transform skip hyperprior analysis branch is (H₁−1)/2 and S_{2,i} is equal to 2 S_{1,i}. In this case, S_{1,i} may represent a scaling factor for i-th feature extraction unit in the hyperprior analysis branch, S_{2,i} may represent a scaling factor for i-th feature extraction unit in the transform skip hyperprior analysis branch, and i is an integer number.

In some embodiments, at least one of: a first or a last feature extraction unit in the hyperprior analysis branch is replaced by the set of feature extraction units related to transform skip, and feature extraction units in the middle of the hyperprior analysis branch are reserved. In some embodiments, one or more feature extraction units in hyperprior analysis branch is replaced by the set of feature extraction units related to transform skip. For example, any hyperprior extraction unit in the main hyperprior analysis may be replaced by transform skip inspired hyperprior extraction units.

In some embodiments, a transform skip hyperprior analysis branch that includes the transform skip module is parallel to a hyperprior analysis branch of the compression framework. In some embodiments, the number of features extraction units (i.e., H₂) in the transform skip hyperprior analysis branch is zero.

In some embodiments, the number of feature extraction units in the transform skip hyperprior analysis branch is H₁/2 and S_{2,i} is equal to 2 S_{1,i}. Alternatively, the number of feature extraction units in the transform skip hyperprior analysis branch is H₁/4 and S_{2,i} is equal to 4 S_{1,i}. In this case, S_{1,i} may represent a scaling factor for i-th feature extraction unit in the hyperprior analysis branch, S_{2,i} may represent a scaling factor for i-th feature extraction unit in the transform skip hyperprior analysis branch, and i is an integer number.

In some embodiments, the number of feature extraction units in the transform skip hyperprior analysis branch is 2ⁿ and S_{2,i} is equal to 2^{k}. In this case, n and k are positive values. In one example, n may be 4 and k may be 2. In one example, n may be 4 and k may be 2. N may be 2 and S₂ may be 4.

In some embodiments, the transform skip module is applied in a hyperprior synthesis stage of the compression process. In some embodiments, an input of the hyperprior synthesis stage is a latent code of a hyper-prior. In some embodiments, a hyperprior synthesis branch in the hyperprior synthesis stage comprises H₃ hyperprior reconstruction units. In some embodiments, a transform skip hyperprior reconstruction branch that includes the transform skip module comprises H₄ hyperprior reconstruction units. In this case, H₄ is not larger than H₃, H₃ and H₄ are integer numbers. For example, the input of the hyperprior synthesis stage is the latent code of the hyper-prior \hat{z}. The main hyperprior synthesis branch contains H₃ hyperprior reconstruction unit (e.g., convolution layer, residual block). The associated scaling factor for the i-th reconstruction unit is S_{3,i}. The transform skip inspired hyperprior synthesis branch contains H₄ hyperprior reconstruction unit (e.g., convolution layer, residual block). The associated scaling factor for the i-th feature reconstruction unit is S_{4,i}.

In some embodiments, a transform skip hyperprior reconstruction branch that includes the transform skip module substitutes an entire hyperprior synthesis branch of the compression framework. In some embodiments, the number of hyperprior reconstruction units (i.e., H₄) in the transform skip hyperprior reconstruction branch is zero.

In some embodiments, the number of hyperprior reconstruction units in the transform skip hyperprior reconstruction branch is H₃/2 and S_{4,i} is equal to 2 S_{3,i}. Alternatively, the number of hyperprior reconstruction units in the transform skip hyperprior reconstruction branch is H₃/4 and S_{4,i} is equal to 4 S_{3,i}. In this case, S_{3,i} may represent a scaling factor for i-th hyperprior reconstruction units in the hyperprior reconstruction branch, S_{4,i} may represent a scaling factor for i-th hyperprior reconstruction units in the transform skip hyperprior reconstruction branch, and i is an integer number.

In some embodiments, the number of hyperprior reconstruction units in the transform skip hyperprior reconstruction branch is 2ⁿ and S_{4,i} is equal to 2^{k}. In this case, n and k are positive values. In one example, n may be 4 and k may be 2. Alternatively, n may be 2 and k may be 4.

In some embodiments, a portion of the hyperprior reconstruction units in the hyperprior analysis branch is replaced by a set of hyperprior reconstruction units related to transform skip. In this case, a hyperprior reconstruction unit related to transform skip may include a larger scaling ratio than that of the hyperprior reconstruction unit in the hyperprior synthesis branch of the compression framework.

In some embodiments, at least one of: a first or a hyperprior reconstruction unit in the hyperprior synthesis branch is reserved, and feature extraction units in the middle of the hyperprior synthesis branch are replaced by the set of hyperprior reconstruction units related to transform skip. In some embodiments, the number of hyperprior reconstruction units related to transform skip in the transform skip hyperprior synthesis branch is (H₃−1)/2 and S_{4,i} is equal to 2 S_{3,i}. In this case, S_{3,i} may represent a scaling factor for i-th hyperprior reconstruction unit in the hyperprior synthesis branch, S_{4,i} may represent a scaling factor for i-th hyperprior reconstruction unit in the transform skip hyperprior synthesis branch, and i is an integer number.

In some embodiments, at least one of: a first or a last hyperprior reconstruction unit in the hyperprior synthesis branch is replaced by the set of hyperprior reconstruction units related to transform skip, and hyperprior reconstruction units in the middle of the hyperprior synthesis branch are reserved. In some embodiments, one or more hyperprior reconstruction units in hyperprior synthesis branch is replaced by the set of hyperprior reconstruction units related to transform skip. For example, any hyperprior reconstruction unit in the main hyperprior synthesis may be replaced by transform skip inspired hyperprior reconstruction units.

In some embodiments, a transform skip hyperprior synthesis branch that includes the transform skip module is parallel to a hyperprior synthesis branch of the compression framework. In some embodiments, the number of hyperprior reconstruction units in the transform skip hyperprior synthesis branch is zero.

In some embodiments, the number of hyperprior reconstruction units in the transform skip hyperprior synthesis branch is H₃/2 and S_{4,i} is equal to 2 S_{3,i}. Alternatively, the number of hyperprior reconstruction units in the transform skip hyperprior synthesis branch is H₃/4 and S_{4,i} is equal to 4 S_{3,i}. In this case, S_{3,i} may represent a scaling factor for i-th hyperprior reconstruction unit in the hyperprior synthesis branch, S_{4,i} may represent a scaling factor for i-th hyperprior reconstruction unit in the transform skip hyperprior synthesis branch, and i is an integer number.

In some embodiments, the number of hyperprior reconstruction units in the transform skip hyperprior synthesis branch is 2ⁿ and S_{4,i} is equal to 2^{k}. In this case, n and k may be positive values. In one example, n may be 4 and k may be 2. Alternatively, n may be 2 and k may be 4.

In some embodiments, the transform skip module is applied in a transform synthesis stage of the compression process. In some embodiments, an input of the transform synthesis state is a latent code from an entropy decoder. In some embodiments, a transform synthesis branch in the transform synthesis stage comprises T₃ feature reconstruction units. In some embodiments, a transform skip synthesis branch that includes the transform skip module comprises T₄ feature reconstruction units. In some embodiments, T₄ is not larger than T₃, T₃ and T₄ are integer numbers. The input may be the latent code ŷ from the entropy decoder. The transform synthesis branch contains T₃ feature reconstruction unit (e.g., convolution layer, residual block). The associated scaling factor for the i-th feature reconstruction unit is S_{3,i}. The transform skip inspired feature reconstruction branch contains T₄ feature reconstruction unit (e.g., convolution layer, residual block). The associated scaling factor for the i-th feature reconstruction unit is S_{4,i}. T₄ should not be larger than T₃. S_{3,i} and S_{4,i} should be non-negative.

In some embodiments, the transform skip synthesis branch that includes the transform skip module substitutes an entire main transform synthesis branch of the compression framework. In some embodiments, the number of features reconstruction units (i.e., T₄) in the transform skip synthesis branch is zero.

In some embodiments, the number of feature reconstruction units in the transform skip synthesis branch is T₃/2 and S_{4,i} is equal to 2 S_{3,i}. Alternatively, the number of feature reconstruction units in the transform skip synthesis branch is T₃/4 and S_{4,i} is equal to 4 S_{3,i}. In this case, S_{3,i} may represent a scaling factor for i-th reconstruction extraction unit in the transform synthesis branch, S_{4,i} may represent a scaling factor for i-th feature reconstruction unit in the transform skip synthesis branch, and i is an integer number.

In some embodiments, the number of feature reconstruction units in the transform skip synthesis branch is 2ⁿ and S_{4,i} is equal to 2^{k}. In this case, n and k may be positive values. In one example, n may be 4 and k may be 2. Alternatively, n may be 2 and k may be 4.

In some embodiments, a portion of feature reconstruction units in a main transform synthesis branch is replaced by a set of feature reconstruction units related to transform skip. In some embodiments, a feature reconstruction unit related to transform skip comprises a larger scaling ratio than that of the feature reconstruction unit in the main transform synthesis branch of the compression framework.

In some embodiments, at least one of: a first or a last feature reconstruction unit in the main transform synthesis branch is reserved, and feature reconstruction units in the middle of the main transform synthesis branch are replaced by the set of feature reconstruction units related to transform skip. In some embodiments, the number of feature reconstruction units related to transform skip in the transform skip synthesis branch is (T₃−1)/2 and S_{4,i} is equal to 2 S_{3,i}. In this case, S_{3,i} may represent a scaling factor for i-th feature reconstruction unit in the transform synthesis branch, S_{4,i} may represent a scaling factor for i-th feature reconstruction unit in the transform skip synthesis branch, and i is an integer number.

In some embodiments, at least one of: a first or a last feature reconstruction unit in the main transform branch is replaced by the set of feature reconstruction units related to transform skip, and feature reconstruction units in the middle of the main transform synthesis branch are reserved. In some embodiments, one or more feature reconstruction units in the main transform synthesis branch are replaced by the set of feature reconstruction units related to transform skip. For example, any feature reconstruction unit in the main synthesis branch may be replaced by transform skip inspired feature reconstruction unit.

In some embodiments, a transform skip synthesis branch that includes the transform skip module is parallel to a main transform synthesis branch of the compression framework. In some embodiments, the number of features reconstruction units in the transform skip synthesis branch is zero.

In some embodiments, a scaling factor controls changing of a dimension of features, wherein the dimension is a spatial resolution and a channel-wise dimension. For example, the scaling factor controls the dimension changing of the features, where the dimension may be the spatial resolution (W×H), and channel-wise dimension (C).

In some embodiments, the dimension of the features is constantly shrinking in encoding phase, the dimension of the features is constantly enlarging in decoding phase, and wherein a final output picture is aligned to size of the video unit. In some embodiments, only the spatial resolution is changing during encoding phase and decoding phase. Alternatively, only the channel-wise dimension is changing during encoding phase and decoding phase. Alternatively, both the spatial resolution and the channel-wise dimension are changing during encoding phase and decoding phase. In some embodiments, whether to change at least one of: the spatial resolution or the channel-wise dimension is indicated to a decoder side.

In some embodiments, the dimension of the features is not constantly shrinking in encoding phase, the dimension of the features is not constantly enlarging in decoding phase, and up-scaling and down-scaling operations are interlaced. In some embodiments, a dimension change is only applied to the spatial resolution. Alternatively, the dimension change is only applied to the channel-wise dimension. Alternatively, the dimension change is applied to the spatial resolution and the channel-wise dimension. In some embodiments, whether to apply the up-scaling and down-scaling operations is indicated, and/or a way of applying the up-scaling and down-scaling operations is indicated.

In some embodiments, the compression framework comprises a main branch and a transform skip branch that includes the transform skip module, and a first output of the main branch and a second output of the transform skip branch are combined and fed to a next stage in the compression framework. The outputs of the main branch O₁ (e.g. main analysis branch, hyperprior analysis branch, hyperprior synthesis branch and main synthesis branch) and the outputs of corresponding transform inspired branch O₂ may be combined and fed to the next stage.

In some embodiments, a combination of the first and second outputs is a weighted sum of the first output and the second output. In some embodiments, an associated weight for the first and second outputs is 0.5. In some embodiments, a first weight of the first output is 1, and a second weight of the second output is 0. Alternatively, the first weight of the first output is 0, and the second weight of the second output is 1. Alternatively, the first weight of the first output is w1, and the second weight of the second output is w2. Alternatively, w1 and w2 are non-zero numbers. Alternatively, the first weight of the first output and the second weight of the second output are indicated.

In some embodiments, a combination of the first and second outputs is through a convolutional layer with a size of N*N. In some embodiments, N equals to 3 or 1.

In some embodiments, a place where the first output and the second output retain is adaptively selected and indicated. For example, where to retain the O₁ and O₂ may be adaptively selected and signaled.

In some embodiments, a flag is indicated to indicate whether to retain the first output or the second output. In some embodiments, an additional flag is indicated if both the first and second outputs will be retained. In some embodiments, the first output is from a main analysis branch and the second output is from a transform skip analysis branch. Alternatively, the first output is from a hyperprior analysis branch and the second output is from a transform skip hyperprior analysis branch. Alternatively, the first output is from a main synthesis branch and the second output is from a transform skip synthesis branch. Alternatively, the first output is from a hyperprior synthesis branch and the second output is from a transform skip hyperprior synthesis branch.

In one example, one or more flags may be signaled to indicate whether to retain the output of main analysis branch or the associated transform inspired analysis branch. Alternatively, one additional flag may be signaled if both outputs of the two branches will be retained.

In one example, one or more flags may be signaled to indicate whether to retain the output of hyperprior analysis branch or the associated transform inspired hyperprior analysis branch. Alternatively, one additional flag may be signaled if both outputs of the two branches will be retained.

In one example, one or more flags may be signaled to indicate whether to retain the output of the hyperprior synthesis branch or the associated transform inspired hyperprior synthesis branch. Alternatively, one additional flag may be signaled if both outputs of the two branches will be retained.

In one example, one or more flag may be signaled to indicate whether to retain the output of the main synthesis branch or the associated transform inspired synthesis branch. Alternatively, one additional flag may be signaled if both outputs of the two branches will be retained.

According to further embodiments of the present disclosure, a non-transitory computer-readable recording medium is provided. The non-transitory computer-readable recording medium stores a bitstream of a video which is generated by a method performed by an apparatus for video processing. The method comprises: applying a compression process to a video unit of the video based on a compression framework, wherein the compression framework comprises a transform skip module; and generating a bitstream of the video based on the compressed video unit.

According to still further embodiments of the present disclosure, a method for storing bitstream of a video is provided. The method comprises: applying a compression process to a video unit of the video based on a compression framework, wherein the compression framework comprises a transform skip module; generating a bitstream of the video based on the compressed video unit; and storing the bitstream in a non-transitory computer-readable recording medium.

Implementations of the present disclosure can be described in view of the following clauses, the features of which can be combined in any reasonable manner.

Clause 1. A method of video processing, comprising applying, during a conversion between a video unit of a video and a bitstream of the video unit, a compression process to the video unit based on a compression framework, wherein the compression framework comprises a transform skip module; and performing the conversion based on the compressed video unit.

Clause 2. The method of clause 1, wherein the transform skip module is a connection in the compression framework that directly passes an input signal related the video unit to at least one of: an intermediate stage or a final stage of the compression framework.

Clause 3. The method of clause 1, wherein the transform skip module is a subset of the compression framework that comprises less feature extraction units and larger scaling ratios than those of other modules of the compression framework.

Clause 4. The method of clause 1, wherein the transform skip module is applied in a transform analysis stage of the compression process, wherein an input of the transform analysis state is a visual signal or features of the visual signal, wherein a transform analysis branch in the transform analysis stage comprises T₁ feature extraction units, wherein a transform skip analysis branch that includes the transform skip module comprises T₂ feature extraction units, and wherein T₂ is not larger than T₁, T₁ and T₂ are integer numbers.

Clause 5. The method of clause 4, wherein a transform skip analysis branch that includes the transform skip module substitutes an entire main transform branch of the compression framework.

Clause 6. The method of clause 5, wherein the number of features extraction units in the transform skip analysis branch is zero.

Clause 7. The method of clause 5, wherein the number of feature extraction units in the transform skip analysis branch is T₁/2 and S_{2,i} is equal to 2S_{1,i}, or wherein the number of feature extraction units in the transform skip analysis branch is T₁/4 and S_{2,i} is equal to 4 S_{1,i}, and wherein S_{1,i} represents a scaling factor for i-th feature extraction unit in the transform analysis branch, S_{2,i} represents a scaling factor for i-th feature extraction unit in the transform skip analysis branch, and i is an integer number.

Clause 8. The method of clause 5, wherein the number of feature extraction units in the transform skip analysis branch is 2n and S_{2,i} is equal to 2^{k}, wherein n and k are positive values.

Clause 9. The method of clause 8, wherein n is 4 and k is 2, or wherein n is 2 and k is 4.

Clause 10. The method of clause 4, wherein a portion of feature extraction units in a main transform branch is replaced by a set of feature extraction units related to transform skip, and wherein a feature extraction unit related to transform skip comprises a larger scaling ratio than that of the feature extraction unit in the main transform branch of the compression framework.

Clause 11. The method of clause 10, wherein at least one of: a first or a last feature extraction unit in the main transform branch is reserved, and feature extraction units in the middle of the main transform branch are replaced by the set of feature extraction units related to transform skip.

Clause 12. The method of clause 11, wherein the number of feature extraction units related to transform skip in the transform skip analysis branch is (T₁−1)/2 and S_{2,i} is equal to 2 S_{1,i}, and wherein S_{1,i} represents a scaling factor for i-th feature extraction unit in the transform analysis branch, S_{2,i} represents a scaling factor for i-th feature extraction unit in the transform skip analysis branch, and i is an integer number.

Clause 13. The method of clause 10, wherein at least one of: a first or a last feature extraction unit in the main transform branch is replaced by the set of feature extraction units related to transform skip, and feature extraction units in the middle of the main transform branch are reserved.

Clause 14. The method of clause 10, wherein one or more feature extraction units in the main transform branch is replaced by the set of feature extraction units related to transform skip.

Clause 15. The method of clause 4, wherein a transform skip analysis branch that includes the transform skip module is parallel to a main transform branch of the compression framework.

Clause 16. The method of clause 15, wherein the number of features extraction units in the transform skip analysis branch is zero.

Clause 17. The method of clause 15, wherein the number of feature extraction units in the transform skip analysis branch is T₁/2 and S_{2,i} is equal to 2 S_{1,i}, or wherein the number of feature extraction units in the transform skip analysis branch is T₁/4 and S_{2,i} is equal to 4 S_{1,i}, and wherein S_{1,i} represents a scaling factor for i-th feature extraction unit in the transform analysis branch, S_{2,i} represents a scaling factor for i-th feature extraction unit in the transform skip analysis branch, and i is an integer number.

Clause 18. The method of clause 15, wherein the number of feature extraction units in the transform skip analysis branch is 2ⁿ and S_{2,i} is equal to 2^{k}, wherein n and k are positive values.

Clause 19. The method of clause 18, wherein n is 4 and k is 2, or wherein n is 2 and k is 4, or wherein n is 2 and S₂ is equal to 4.

Clause 20. The method of clause 1, wherein the transform skip module is applied in a hyperprior analysis stage of the compression process, wherein an input of the hyperprior analysis stage is latent code y, wherein a hyperprior analysis branch in the hyperprior analysis stage comprises H₁ feature extraction units, wherein a transform skip hyperprior analysis branch that includes the transform skip module comprises H₂ feature extraction units, and wherein H₂ is not larger than H₁, H₁ and H₂ are integer numbers.

Clause 21. The method of clause 20, wherein the transform skip hyperprior analysis branch that includes the transform skip module substitutes an entire hyperprior analysis branch of the compression framework.

Clause 22. The method of clause 21, wherein the number of features extraction units in the transform skip hyperprior analysis branch is zero.

Clause 23. The method of clause 21, wherein the number of feature extraction units in the transform skip hyperprior analysis branch is H₁/2 and S_{2,i} is equal to 2 S_{1,i}, or wherein the number of feature extraction units in the transform skip hyperprior analysis branch is H₁/4 and S_{2,i} is equal to 4 S_{1,i}, and wherein S_{2,i} represents a scaling factor for i-th feature extraction unit in the hyperprior analysis branch, S_{2,i} represents a scaling factor for i-th feature extraction unit in the transform skip hyperprior analysis branch, and i is an integer number.

Clause 24. The method of clause 21, wherein the number of feature extraction units in the transform skip hyperprior analysis branch is 2ⁿ and S_{2,i} is equal to 2^{k}, wherein n and k are positive values.

Clause 25. The method of clause 24, wherein n is 4 and k is 2, or wherein n is 2 and k is 4.

Clause 26. The method of clause 20, wherein a portion of feature extraction units in a hyperprior analysis branch is replaced by a set of feature extraction units related to transform skip, and wherein a feature extraction unit related to transform skip comprises a larger scaling ratio than that of the feature extraction unit in the hyperprior analysis branch of the compression framework.

Clause 27. The method of clause 26, wherein at least one of: a first or a last feature extraction unit in the hyperprior analysis branch is reserved, and feature extraction units in the middle of the hyperprior analysis branch are replaced by the set of feature extraction units related to transform skip.

Clause 28. The method of clause 27, wherein the number of feature extraction units related to transform skip in the transform skip hyperprior analysis branch is (H₁−1)/2 and S_{2,i} is equal to 2S_{1,i}, and wherein Shi represents a scaling factor for i-th feature extraction unit in the hyperprior analysis branch, S_{2,i} represents a scaling factor for i-th feature extraction unit in the transform skip hyperprior analysis branch, and i is an integer number.

Clause 29. The method of clause 26, wherein at least one of: a first or a last feature extraction unit in the hyperprior analysis branch is replaced by the set of feature extraction units related to transform skip, and feature extraction units in the middle of the hyperprior analysis branch are reserved.

Clause 30. The method of clause 26, wherein one or more feature extraction units in hyperprior analysis branch is replaced by the set of feature extraction units related to transform skip.

Clause 31. The method of clause 20, wherein a transform skip hyperprior analysis branch that includes the transform skip module is parallel to a hyperprior analysis branch of the compression framework.

Clause 32. The method of clause 31, wherein the number of features extraction units in the transform skip hyperprior analysis branch is zero.

Clause 33. The method of clause 31, wherein the number of feature extraction units in the transform skip hyperprior analysis branch is H₁/2 and S_{2,i} is equal to 2 S_{1,i}, or wherein the number of feature extraction units in the transform skip hyperprior analysis branch is H₁/4 and S_{2,i} is equal to 4 S_{1,i}, and wherein S_{2,i} represents a scaling factor for i-th feature extraction unit in the hyperprior analysis branch, S_{2,i} represents a scaling factor for i-th feature extraction unit in the transform skip hyperprior analysis branch, and i is an integer number.

Clause 34. The method of clause 31, wherein the number of feature extraction units in the transform skip hyperprior analysis branch is 2ⁿ and S_{2,i} is equal to 2^{k}, wherein n and k are positive values.

Clause 35. The method of clause 34, wherein n is 4 and k is 2, or wherein n is 2 and k is 4, or wherein n is 2 and S₂ is equal to 4.

Clause 36. The method of clause 1, wherein the transform skip module is applied in a hyperprior synthesis stage of the compression process, wherein an input of the hyperprior synthesis stage is a latent code of a hyper-prior, wherein a hyperprior synthesis branch in the hyperprior synthesis stage comprises H₃ hyperprior reconstruction units, wherein a transform skip hyperprior reconstruction branch that includes the transform skip module comprises H₄ hyperprior reconstruction units, and wherein H₄ is not larger than H₃, H₃ and H₄ are integer numbers.

Clause 37. The method of clause 36, wherein a transform skip hyperprior reconstruction branch that includes the transform skip module substitutes an entire hyperprior synthesis branch of the compression framework.

Clause 38. The method of clause 37, wherein the number of hyperprior reconstruction units in the transform skip hyperprior reconstruction branch is zero.

Clause 39. The method of clause 37, wherein the number of hyperprior reconstruction units in the transform skip hyperprior reconstruction branch is H₃/2 and S_{4,i} is equal to 2S_{3,i}, or wherein the number of hyperprior reconstruction units in the transform skip hyperprior reconstruction branch is H₃/4 and S_{4,i} is equal to 4 S_{3,i}, and wherein S_{3,i} represents a scaling factor for i-th hyperprior reconstruction units in the hyperprior reconstruction branch, S_{4,i} represents a scaling factor for i-th hyperprior reconstruction units in the transform skip hyperprior reconstruction branch, and i is an integer number.

Clause 40. The method of clause 37, wherein the number of hyperprior reconstruction units in the transform skip hyperprior reconstruction branch is 2ⁿ and S_{4,i} is equal to 2^{k}, wherein n and k are positive values.

Clause 41. The method of clause 40, wherein n is 4 and k is 2, or wherein n is 2 and k is 4.

Clause 42. The method of clause 36, wherein a portion of the hyperprior reconstruction units in the hyperprior analysis branch is replaced by a set of hyperprior reconstruction units related to transform skip, and wherein a hyperprior reconstruction unit related to transform skip comprises a larger scaling ratio than that of the hyperprior reconstruction unit in the hyperprior synthesis branch of the compression framework.

Clause 43. The method of clause 42, wherein at least one of: a first or a hyperprior reconstruction unit in the hyperprior synthesis branch is reserved, and feature extraction units in the middle of the hyperprior synthesis branch are replaced by the set of hyperprior reconstruction units related to transform skip.

Clause 44. The method of clause 43, wherein the number of hyperprior reconstruction units related to transform skip in the transform skip hyperprior synthesis branch is (H₃−1)/2 and S_{4,i} is equal to 2 S_{3,i}, and wherein S_{3,i} represents a scaling factor for i-th hyperprior reconstruction unit in the hyperprior synthesis branch, S_{4,i} represents a scaling factor for i-th hyperprior reconstruction unit in the transform skip hyperprior synthesis branch, and i is an integer number.

Clause 45. The method of clause 42, wherein at least one of: a first or a last hyperprior reconstruction unit in the hyperprior synthesis branch is replaced by the set of hyperprior reconstruction units related to transform skip, and hyperprior reconstruction units in the middle of the hyperprior synthesis branch are reserved.

Clause 46. The method of clause 42, wherein one or more hyperprior reconstruction units in hyperprior synthesis branch is replaced by the set of hyperprior reconstruction units related to transform skip.

Clause 47. The method of clause 36, wherein a transform skip hyperprior synthesis branch that includes the transform skip module is parallel to a hyperprior synthesis branch of the compression framework.

Clause 48. The method of clause 47, wherein the number of hyperprior reconstruction units in the transform skip hyperprior synthesis branch is zero.

Clause 49. The method of clause 47, wherein the number of hyperprior reconstruction units in the transform skip hyperprior synthesis branch is H₃/2 and S_{4,i} is equal to 2 S_{3,i}, or wherein the number of hyperprior reconstruction units in the transform skip hyperprior synthesis branch is H₃/4 and S_{4,i} is equal to 4 S_{3,i}, and wherein S_{3,i} represents a scaling factor for i-th hyperprior reconstruction unit in the hyperprior synthesis branch, S_{4,i} represents a scaling factor for i-th hyperprior reconstruction unit in the transform skip hyperprior synthesis branch, and i is an integer number.

Clause 50. The method of clause 47, wherein the number of hyperprior reconstruction units in the transform skip hyperprior synthesis branch is 2ⁿ and S_{4,i} is equal to 2^{k}, wherein n and k are positive values.

Clause 51. The method of clause 50, wherein n is 4 and k is 2, or wherein n is 2 and k is 4, or wherein n is 2 and S₂ is equal to 4.

Clause 52. The method of clause 1, wherein the transform skip module is applied in a transform synthesis stage of the compression process, wherein an input of the transform synthesis state is a latent code from an entropy decoder, wherein a transform synthesis branch in the transform synthesis stage comprises T₃ feature reconstruction units, wherein a transform skip synthesis branch that includes the transform skip module comprises T₄ feature reconstruction units, and wherein T₄ is not larger than T₃, T₃ and T₄ are integer numbers.

Clause 53. The method of clause 52, wherein the transform skip synthesis branch that includes the transform skip module substitutes an entire main transform synthesis branch of the compression framework.

Clause 54. The method of clause 53, wherein the number of features reconstruction units in the transform skip synthesis branch is zero.

Clause 55. The method of clause 53, wherein the number of feature reconstruction units in the transform skip synthesis branch is T₃/2 and S_{4,i} is equal to 2 S_{3,i}, or wherein the number of feature reconstruction units in the transform skip synthesis branch is T₃/4 and S_{4,i} is equal to 4 S_{3,i}, and wherein S_{3,i} represents a scaling factor for i-th reconstruction extraction unit in the transform synthesis branch, S_{4,i} represents a scaling factor for i-th feature reconstruction unit in the transform skip synthesis branch, and i is an integer number.

Clause 56. The method of clause 53, wherein the number of feature reconstruction units in the transform skip synthesis branch is 2ⁿ and S_{4,i} is equal to 2^{k}, wherein n and k are positive values.

Clause 57. The method of clause 59, wherein n is 4 and k is 2, or wherein n is 2 and k is 4.

Clause 58. The method of clause 52, wherein a portion of feature reconstruction units in a main transform synthesis branch is replaced by a set of feature reconstruction units related to transform skip, and wherein a feature reconstruction unit related to transform skip comprises a larger scaling ratio than that of the feature reconstruction unit in the main transform synthesis branch of the compression framework.

Clause 59. The method of clause 58, wherein at least one of: a first or a last feature reconstruction unit in the main transform synthesis branch is reserved, and feature reconstruction units in the middle of the main transform synthesis branch are replaced by the set of feature reconstruction units related to transform skip.

Clause 60. The method of clause 59, wherein the number of feature reconstruction units related to transform skip in the transform skip synthesis branch is (T₃−1)/2 and S_{4,i} is equal to 2 S_{3,i}, and wherein S_{3,i} represents a scaling factor for i-th feature reconstruction unit in the transform synthesis branch, Si represents a scaling factor for i-th feature reconstruction unit in the transform skip synthesis branch, and i is an integer number.

Clause 61. The method of clause 58, wherein at least one of: a first or a last feature reconstruction unit in the main transform branch is replaced by the set of feature reconstruction units related to transform skip, and feature reconstruction units in the middle of the main transform synthesis branch are reserved.

Clause 62. The method of clause 58, wherein one or more feature reconstruction units in the main transform synthesis branch are replaced by the set of feature reconstruction units related to transform skip.

Clause 63. The method of clause 52, wherein a transform skip synthesis branch that includes the transform skip module is parallel to a main transform synthesis branch of the compression framework.

Clause 64. The method of clause 63, wherein the number of features reconstruction units in the transform skip synthesis branch is zero.

Clause 65. The method of clause 1, wherein a scaling factor controls changing of a dimension of features, wherein the dimension is a spatial resolution and a channel-wise dimension.

Clause 66. The method of clause 65, wherein the dimension of the features is constantly shrinking in encoding phase, wherein the dimension of the features is constantly enlarging in decoding phase, and wherein a final output picture is aligned to size of the video unit.

Clause 67. The method of clause 65, wherein only the spatial resolution is changing during encoding phase and decoding phase, or wherein only the channel-wise dimension is changing during encoding phase and decoding phase, or wherein both the spatial resolution and the channel-wise dimension are changing during encoding phase and decoding phase.

Clause 68. The method of clause 65, wherein whether to change at least one of: the spatial resolution or the channel-wise dimension is indicated to a decoder side.

Clause 69. The method of clause 65, wherein the dimension of the features is not constantly shrinking in encoding phase, wherein the dimension of the features is not constantly enlarging in decoding phase, and wherein up-scaling and down-scaling operations are interlaced.

Clause 70. The method of clause 69, wherein a dimension change is only applied to the spatial resolution, or wherein the dimension change is only applied to the channel-wise dimension, or wherein the dimension change is applied to the spatial resolution and the channel-wise dimension.

Clause 71. The method of clause 69, wherein whether to apply the up-scaling and down-scaling operations is indicated, and/or wherein a way of applying the up-scaling and down-scaling operations is indicated.

Clause 72. The method of clause 1, wherein the compression framework comprises a main branch and a transform skip branch that includes the transform skip module, and wherein a first output of the main branch and a second output of the transform skip branch are combined and fed to a next stage in the compression framework.

Clause 73. The method of clause 72, wherein a combination of the first and second outputs is a weighted sum of the first output and the second output.

Clause 74. The method of clause 73, wherein an associated weight for the first and second outputs is 0.5.

Clause 75. The method of clause 73, wherein a first weight of the first output is 1, and a second weight of the second output is 0, or wherein the first weight of the first output is 0, and the second weight of the second output is 1, or wherein the first weight of the first output is w1, and the second weight of the second output is w2, wherein w1 and w2 are non-zero numbers, or wherein the first weight of the first output and the second weight of the second output are indicated.

Clause 76. The method of clause 72, wherein a combination of the first and second outputs is through a convolutional layer with a size of N*N.

Clause 77. The method of clause 76, wherein N equals to 3 or 1.

Clause 78. The method of clause 72, wherein a place where the first output and the second output retain is adaptively selected and indicated.

Clause 79. The method of clause 78, wherein a flag is indicated to indicate whether to retain the first output or the second output.

Clause 80. The method of clause 79, wherein an additional flag is indicated if both the first and second outputs will be retained.

Clause 81. The method of clause 78 or 79, wherein the first output is from a main analysis branch and the second output is from a transform skip analysis branch, or wherein the first output is from a hyperprior analysis branch and the second output is from a transform skip hyperprior analysis branch, or wherein the first output is from a main synthesis branch and the second output is from a transform skip synthesis branch, or wherein the first output is from a hyperprior synthesis branch and the second output is from a transform skip hyperprior synthesis branch.

Clause 82. The method of any of clause 1-81, wherein the conversion includes encoding the video unit into the bitstream.

Clause 83. The method of any of clause 1-81, wherein the conversion includes decoding the video unit from the bitstream.

Clause 84. An apparatus for video processing comprising a processor and a non-transitory memory with instructions thereon, wherein the instructions upon execution by the processor, cause the processor to perform a method in accordance with any of clauses 1-83.

Clause 85. A non-transitory computer-readable storage medium storing instructions that cause a processor to perform a method in accordance with any of clauses 1-83.

Clause 86. A non-transitory computer-readable recording medium storing a bitstream of a video which is generated by a method performed by an apparatus for video processing, wherein the method comprises: applying a compression process to a video unit of the video based on a compression framework, wherein the compression framework comprises a transform skip module; and generating a bitstream of the video based on the compressed video unit.

Clause 87. A method for storing a bitstream of a video, comprising: applying a compression process to a video unit of the video based on a compression framework, wherein the compression framework comprises a transform skip module; generating a bitstream of the video based on the compressed video unit; and storing the bitstream in a non-transitory computer-readable recording medium.

### Example Device

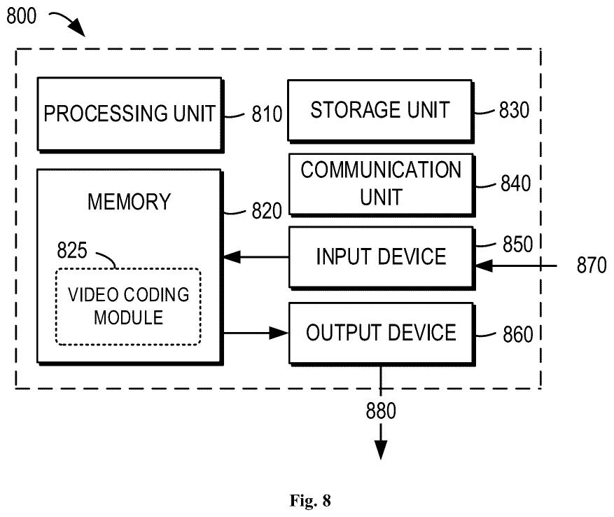

FIG. 8 illustrates a block diagram of a computing device 800 in which various embodiments of the present disclosure can be implemented. The computing device 800 may be implemented as or included in the source device 110 (or the video encoder 114 or 200) or the destination device 120 (or the video decoder 124 or 300).

It would be appreciated that the computing device 800 shown in FIG. 8 is merely for purpose of illustration, without suggesting any limitation to the functions and scopes of the embodiments of the present disclosure in any manner.

As shown in FIG. 8, the computing device 800 includes a general-purpose computing device 800. The computing device 800 may at least comprise one or more processors or processing units 810, a memory 820, a storage unit 830, one or more communication units 840, one or more input devices 850, and one or more output devices 860.

In some embodiments, the computing device 800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 800 can support any type of interface to a user (such as “wearable” circuitry and the like).

The processing unit 810 may be a physical or virtual processor and can implement various processes based on programs stored in the memory 820. In a multi-processor system, multiple processing units execute computer executable instructions in parallel so as to improve the parallel processing capability of the computing device 800. The processing unit 810 may also be referred to as a central processing unit (CPU), a microprocessor, a controller or a microcontroller.

The computing device 800 typically includes various computer storage medium. Such medium can be any medium accessible by the computing device 800, including, but not limited to, volatile and non-volatile medium, or detachable and non-detachable medium. The memory 820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 830 may be any detachable or non-detachable medium and may include a machine-readable medium such as a memory, flash memory drive, magnetic disk or another other media, which can be used for storing information and/or data and can be accessed in the computing device 800.

The computing device 800 may further include additional detachable/non-detachable, volatile/non-volatile memory medium. Although not shown in FIG. 8, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 840 communicates with a further computing device via the communication medium. In addition, the functions of the components in the computing device 800 can be implemented by a single computing cluster or multiple computing machines that can communicate via communication connections. Therefore, the computing device 800 can operate in a networked environment using a logical connection with one or more other servers, networked personal computers (PCs) or further general network nodes.

The input device 850 may be one or more of a variety of input devices, such as a mouse, keyboard, tracking ball, voice-input device, and the like. The output device 860 may be one or more of a variety of output devices, such as a display, loudspeaker, printer, and the like. By means of the communication unit 840, the computing device 800 can further communicate with one or more external devices (not shown) such as the storage devices and display device, with one or more devices enabling the user to interact with the computing device 800, or any devices (such as a network card, a modem and the like) enabling the computing device 800 to communicate with one or more other computing devices, if required. Such communication can be performed via input/output (I/O) interfaces (not shown).

In some embodiments, instead of being integrated in a single device, some or all components of the computing device 800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 800 may be used to implement video encoding/decoding in embodiments of the present disclosure. The memory 820 may include one or more video coding modules 825 having one or more program instructions. These modules are accessible and executable by the processing unit 810 to perform the functionalities of the various embodiments described herein.

In the example embodiments of performing video encoding, the input device 850 may receive video data as an input 870 to be encoded. The video data may be processed, for example, by the video coding module 825, to generate an encoded bitstream. The encoded bitstream may be provided via the output device 860 as an output 880.

In the example embodiments of performing video decoding, the input device 850 may receive an encoded bitstream as the input 870. The encoded bitstream may be processed, for example, by the video coding module 825, to generate decoded video data. The decoded video data may be provided via the output device 860 as the output 880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
applying, during a conversion between a video unit of a video and a bitstream of the video unit, a compression process to the video unit based on a compression framework, wherein the compression framework comprises a transform skip module; and
performing the conversion based on the compressed video unit.

2. The method of claim 1, wherein the transform skip module is a connection in the compression framework that directly passes an input signal related the video unit to at least one of: an intermediate stage or a final stage of the compression framework.

3. The method of claim 1, wherein the transform skip module is a subset of the compression framework that comprises less feature extraction units and larger scaling ratios than those of other modules of the compression framework.

4. The method of claim 1, wherein the transform skip module is applied in a transform analysis stage of the compression process,
wherein an input of the transform analysis state is a visual signal or features of the visual signal,
wherein a transform analysis branch in the transform analysis stage comprises T₁ feature extraction units,
wherein a transform skip analysis branch that includes the transform skip module comprises T₂ feature extraction units, and
wherein T₂ is not larger than T₁, T₁ and T₂ are integer numbers.

5. The method of claim 4, wherein a transform skip analysis branch that includes the transform skip module substitutes an entire main transform branch of the compression framework.

6. The method of claim 4, wherein a portion of feature extraction units in a main transform branch is replaced by a set of feature extraction units related to transform skip, and
wherein a feature extraction unit related to transform skip comprises a larger scaling ratio than that of the feature extraction unit in the main transform branch of the compression framework.

7. The method of claim 4, wherein a transform skip analysis branch that includes the transform skip module is parallel to a main transform branch of the compression framework.

8. The method of claim 1, wherein the transform skip module is applied in a hyperprior analysis stage of the compression process,
wherein an input of the hyperprior analysis stage is latent code y,
wherein a hyperprior analysis branch in the hyperprior analysis stage comprises H₁ feature extraction units,
wherein a transform skip hyperprior analysis branch that includes the transform skip module comprises H₂ feature extraction units, and
wherein H₂ is not larger than H₁, H₁ and H₂ are integer numbers.

9. The method of claim 8, wherein the transform skip hyperprior analysis branch that includes the transform skip module substitutes an entire hyperprior analysis branch of the compression framework.

10. The method of claim 8, wherein a portion of feature extraction units in a hyperprior analysis branch is replaced by a set of feature extraction units related to transform skip, and
wherein a feature extraction unit related to transform skip comprises a larger scaling ratio than that of the feature extraction unit in the hyperprior analysis branch of the compression framework.

11. The method of claim 8, wherein a transform skip hyperprior analysis branch that includes the transform skip module is parallel to a hyperprior analysis branch of the compression framework.

12. The method of claim 1, wherein the transform skip module is applied in a hyperprior synthesis stage of the compression process,
wherein an input of the hyperprior synthesis stage is a latent code of a hyper-prior \hat{z},
wherein a hyperprior synthesis branch in the hyperprior synthesis stage comprises H₃ hyperprior reconstruction units,
wherein a transform skip hyperprior reconstruction branch that includes the transform skip module comprises H₄ hyperprior reconstruction units, and
wherein H₄ is not larger than H₃, H₃ and H₄ are integer numbers.

13. The method of claim 12, wherein a transform skip hyperprior reconstruction branch that includes the transform skip module substitutes an entire hyperprior synthesis branch of the compression framework.

14. The method of claim 1, wherein the transform skip module is applied in a transform synthesis stage of the compression process,
wherein an input of the transform synthesis state is a latent code from an entropy decoder,
wherein a transform synthesis branch in the transform synthesis stage comprises T₃ feature reconstruction units,
wherein a transform skip synthesis branch that includes the transform skip module comprises T₄ feature reconstruction units, and
wherein T₄ is not larger than T₃, T₃ and T₄ are integer numbers.

15. The method of claim 1, wherein a scaling factor controls changing of a dimension of features, wherein the dimension is a spatial resolution and a channel-wise dimension.

16. The method of claim 1, wherein the compression framework comprises a main branch and a transform skip branch that includes the transform skip module, and
wherein a first output of the main branch and a second output of the transform skip branch are combined and fed to a next stage in the compression framework.

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to:
apply, during a conversion between a video unit of a video and a bitstream of the video unit, a compression process to the video unit based on a compression framework, wherein the compression framework comprises a transform skip module; and
perform the conversion based on the compressed video unit.

19. A non-transitory computer-readable storage medium storing instructions that cause a processor to:
apply, during a conversion between a video unit of a video and a bitstream of the video unit, a compression process to the video unit based on a compression framework, wherein the compression framework comprises a transform skip module; and
perform the conversion based on the compressed video unit.

20. A non-transitory computer-readable recording medium storing a bitstream of a video which is generated by a method performed by an apparatus for video processing, wherein the method comprises:
applying a compression process to a video unit of the video based on a compression framework, wherein the compression framework comprises a transform skip module; and
generating a bitstream of the video based on the compressed video unit.
